(19) United States
(12) Patent Application Publication
(10) Pub. No.: US 2006/0292025 A1
(43) Pub. Date: Dec. 28, 2006

(54) Electric internal gear pump

(76) Inventors: Takatoshi Sakata, Yamatotakada-Shi (JP); Yasuhiro Yukitake, Nara (JP); Yasuo Asai, Kashiwara-Shi (JP)

Correspondence Address: BIRCH STEWART KOLASCH & BIRCH, PO BOX 747, FALLS CHURCH, VA, 22040-0747, US

(21) Appl. No.: 10/540,388

(22) PCT Filed: Dec. 22, 2003
(86) PCT No.: PCT/JP03/16507

§ 371 Date: Feb. 24, 2006

(30) Foreign Application Priority Data
Dec. 24, 2002 (JP) 2002-371500
Dec. 24, 2002 (JP) 2002-371501

(51) Int. Cl. F01C 1/08; F01C 1/18; F04C 2/00; F16N 13/20; F04C 18/00

(52) U.S. Cl. 418/191; 418/205

(57) ABSTRACT

A novel electric internal gear pump integrated with motor is provided which has a relatively compact structure adapted for stable support of a main shaft.

The pump includes: a rotor portion 4 having an outer rotor 25 and an inner rotor 26; an electric motor portion 3 for driving the inner rotor 26 into rotation; and a main shaft 5 including a drive shaft of the electric motor portion and a rotary shaft of the inner rotor 26, the drive shaft and rotary shaft formed coaxially and integrally. The main shaft 5 is supported only by a first bearing 10 and a second bearing 16 on axially opposite sides thereof. The rotor portion 4 is interposed between the bearings 10, 16.

### TECHNICAL FIELD

The present invention relates to an electric internal gear pump. More particularly, the invention relates to an electric internal gear pump favorably used as a transmission pump in automotive vehicles.

### FBACKGROUND ART

A common electric pump has an arrangement wherein an electric motor having a drive shaft is connected with a pump having a rotary shaft by means of a coupling. Such an electric motor of a motor-pump combination type requires the coupling for interconnecting the motor drive shaft and the pump rotary shaft, thus requiring a space for installing the coupling. This constitutes an obstacle to the size reduction of the electric pump. In addition, there are problems associated with noises from the coupling, and such.

Furthermore, the motor drive shaft is generally disposed in the motor and has the axially opposite ends thereof supported by bearings. In the case of the electric pump of the motor-pump combination type, the pump also requires bearings for supporting the pump rotary shaft.

Accordingly, the electric pump as a whole employs a large number of bearings, which increases costs and also requires space for installing the bearings. A single unit of pump with bearings is disclosed in, for example, Japanese Unexamined Patent Publication No. 10-259785 and Japanese Unexamined Patent Publication No. 8-200237. In a case where such a pump is combined with a motor, the bearings of the motor are added to increase the total number of bearings.

It may be contemplated to obviate the need for the coupling by designing a single shaft to serve as both the drive shaft of the electric motor and the rotary shaft of the pump. Such a pump is disclosed in Japanese Unexamined Patent Publication No. 9-32738, for example (hereinafter, referred to as “prior-art document”).

The pump of the prior-art document includes the main shaft shared as the drive shaft of the motor and the rotary shaft of the pump. The main shaft is rotatably supported at two opposite points or by a bearing A disposed on a pump side and a bearing B disposed on a motor side. Thus, the number of bearings is reduced.

In the arrangements of the prior-art document, however, the pump is located axially outwardly of the bearing A on the pump side. That is, the pump is located outside of a range where the main shaft is supported by the bearings A, B. A main-shaft portion extended outwardly of the range where the main shaft is supported by the bearings A, B is supported in a so-called outboard-rotor fashion, thus suffering bending in cases. If the pump is disposed outwardly of such a range, a faulty rotation may result.

It may be contemplated to add a bearing such that the main-shaft portion carrying the pump may be supported in an inboard-rotor fashion thereby obviating the faulty rotation. However, the addition of the bearing is not preferred because the number of components is increased to make the pump larger.

Furthermore, the bearing A disposed on the pump side and the pump are juxtaposed in the arrangement of the prior-art document. Accordingly, it is difficult to reduce the axial length. In order to assuredly support the rotation of the main shaft, however, the bearings must be located on the axially opposite sides of the motor. Therefore, is it impossible to omit the bearing A on the pump side.

### DISCLOSURE OF THE INVENTION

The invention has an object to provide a novel electric internal gear pump having a relatively compact structure adapted for stable support of a main shaft.

An electric internal gear pump according to the invention is integrated with motor and comprises: a rotor portion including an outer rotor having an inner gear and an inner rotor having an outer gear meshed with the inner gear; an electric motor portion for driving the inner rotor into rotation; and a main shaft comprising a drive shaft of the electric motor portion and a rotary shaft of the inner rotor, the drive shaft and rotary shaft formed coaxially and integrally.

It is noted here that the internal gear pump means to encompass all kinds of internal gear pumps such as trochoid, involute, parachoid and hypocycloid.

In a first aspect of the invention, the main shaft is supported only by a first bearing and a second bearing on the axially opposite sides thereof. Therefore, a compact structure with a smaller number of bearings is realized. Furthermore, the rotor portion is mounted to the main shaft at a portion between these bearings, which is less prone to bending. Therefore, the rotor portion constituting the pump is prevented from suffering the faulty rotation and operates stably.

In a second aspect of the invention, the main shaft is supported by the first bearing and the second bearing disposed on the axially opposite sides of the electric motor portion. Therefore, the main shaft is supported stably. Furthermore, the first bearing supports the main shaft at the axial end thereof opposite from the rotor portion, whereas the second bearing is disposed on an outer periphery of the outer rotor so as to support the main shaft via the inner rotor. In this manner, the second bearing is disposed on the outer periphery of the outer rotor, so that the second bearing and the rotor portion are not juxtaposed axially. Therefore, the pump may be downsized with respect to the axial direction.

In addition, the second bearing may preferably be a sliding bearing constructed such that the outer periphery of the outer rotor is in sliding contact with a pump housing.

### BRIEF DESCRIPTION OF THE DRAWINGS

FIG. 1 is a sectional view showing an electric internal gear pump according to a first embodiment of the invention;

FIG. 2 is a sectional view showing an electric internal pump according to a comparative example; and

FIG. 3 is a sectional view showing an electric internal gear pump according to a second embodiment of the invention.

### BEST MODES FOR CARRYING OUT THE INVENTION

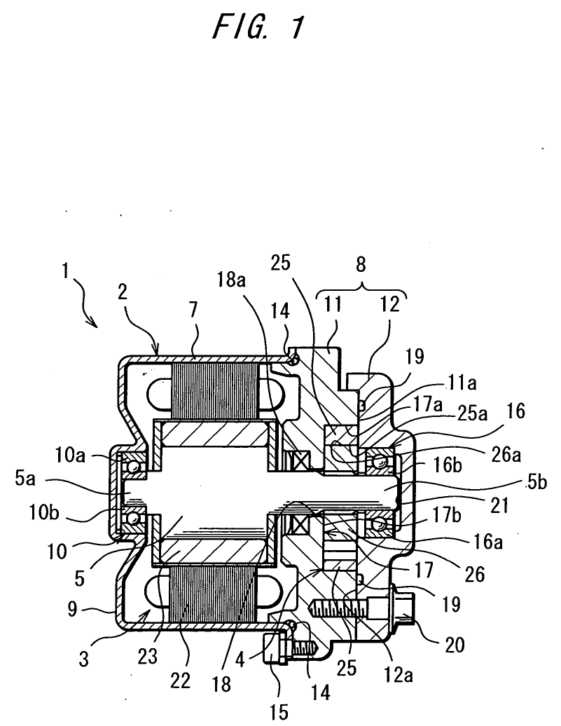

The preferred embodiments of the invention will hereinbelow be described with reference to the accompanying drawings. An electric internal gear pump 1 according to a first embodiment shown in FIG. 1 is a hydraulic pump for automotive transmission, which is required of only a relatively low output of 0.4 MPa to 1 Mpa. This pump 1 is used as an oil pressure source for transmission when an automotive engine has stopped.

The pump 1 is arranged as a trochoid pump which is a kind of internal gear pump. Rather low in efficiency, the trochoid pump is characterized by low pulsation and low noises. Hence, the trochoid pump is preferably used as the transmission pump.

The pump 1 has an arrangement wherein an electric motor portion 3 and a rotor portion 4 are accommodated in a pump housing 2. A main shaft 5 is rotatably provided in the housing 2 and serves as a drive shaft driven into rotation by the motor portion 3 and also as a rotary shaft of the rotor portion 4. As seen in FIG. 1, a left-hand portion of the main shaft 5 functions as the drive shaft of the motor portion 3, whereas a right-hand portion of the main shaft 6 functions as the rotary shaft of the rotor portion 4. Since the drive shaft and the rotary shaft are integrally formed in this manner, the interconnection of these shafts is unnecessary so that the pump may be downsized with respect to an axial direction. The main shaft 5 has its axial opposite ends rotatably supported by bearings 10, 16 mounted in the housing 2.

The housing 2 is formed of a steel sheet and has an arrangement wherein a motor housing 7 principally accommodating the motor portion 3 is connected with a rotor housing 8 principally accommodating the rotor portion 4.

The motor housing 7 is shaped like a cylinder which has a close face 9 on one axial side (opposite side from the rotor portion 4; the left-hand side as seen in FIG. 1) and an open face on the other axial side. A roller bearing (first bearing) 10 for rotatably supporting an axial end 5a of the main shaft 5 is disposed centrally of the one axial face 9 of the motor housing 7. The first bearing 10 has an outer ring 10a mounted to the motor housing 7, and an inner ring 10b mounted to the main shaft 5.

The rotor housing 8 is divided into a first section 11 and a second section 12 which are arranged in an axial direction of the main shaft 5 and connected with each other. The first section 12, assembled to the open face at the other axial end of the motor housing 7, is hermetically mated against the motor housing 7 by means of a seal 14 but is disengageably connected/fixed to the motor housing 7 by means of a bolt 15. A joint face 11a of the first section 11 with the second section 12 is formed with a recess 17 hollowed in a direction of thickness of the first section 11 (the axial direction of the main shaft 5), the recess defining a rotor chamber accommodating the rotor portion 4. The recess 17 includes a peripheral surface 17a eccentric relative to the main shaft 5. Furthermore, the recess is formed with a through-hole 18 at the center of a bottom 17b thereof, the through-hole extended toward the motor housing 7 in the direction of thickness of the first section 11 (the axial direction of the main shaft 5). Thus, the main shaft 5 is inserted through the through-hole 18. The first section 11 is provided with a seal member 18a fitted about the main shaft 5 for sealing the rotor chamber 17 against an interior of the motor housing 7.

The second section 12 is pressed against the joint face 11a of the first section 11, whereas joint faces of the first section 11 and the second section 12 are sealed with a seal 19. The first section 11 and the section 12 are disengageably connected/fixed to each other by means of a bolt 20.

The second section 12 is provided with a roller bearing (second bearing) 16 for rotatably supporting the other axial end of the main shaft 5. In order to mount the second bearing 16, the second section 12 is formed with a recess 21 at its joint face 12a with the first section 11, the recess hollowed in a direction of thickness of the second section 12. An outer ring 16a of the roller bearing 16 is mounted to an inner peripheral surface of the recess 21, whereas an inner ring 16b is mounted to the main shaft 5.

The motor portion 3 includes a stator 22 mounted to an inner side of the motor housing 7, whereas a rotor 23 is disposed on an inner side relative to the stator. The rotor 23 has the main shaft 5, as the drive shaft, fitted therein for unitary rotation, so that the main shaft 5 extends from the rotor 23 in axially opposite directions. The one axial end 5a of the main shaft 5 is rotatably supported by the first bearing 10. On the other hand, the other axial end 5b of the main shaft 5 extends through the through-hole 18 of the first section 11 and the rotor chamber 17 to the recess 21 of the second section 12, so as to be rotatably supported by the second bearing 16.

The rotor portion 4 is disposed in the rotor chamber 17 between the second bearing 16 and the motor portion 3. The rotor portion 4 is a trochoid pump, as described above, which includes: an outer rotor 25 having an inner gear 25a; and an inner rotor 26 having an outer gear 26a meshed with the inner gear 25a. The inner rotor 26 is fitted on the main shaft 5. When the main shaft 5 is driven into rotation by the motor portion 3, the inner rotor 26 is also rotated. When the inner rotor 26 is rotated, the outer rotor 25 meshed therewith is also brought into rotation in an eccentric state, so that a pumping action is produced between the outer rotor 25 and the inner rotor 26. Incidentally, oil is sucked into space between the outer and inner rotors 25, 26 via an unillustrated suction port, and is discharged through an unillustrated discharge port.

According to the first embodiment, the main shaft 5 as the drive shaft of the motor portion 3 is supported by the first bearing 10 and the second bearing 16 at the axially opposite ends 5a, 5b thereof in an inboard-rotor fashion and hence, the main shaft 5 between these bearings 10, 16 is less prone to bending. Further, the rotor portion 4 is disposed between the opposite bearings 10, 16, so that the main shaft 5 also serves as the rotary shaft of the rotor portion 4. Therefore, the rotor portion 4 is prevented from suffering a faulty rotation.

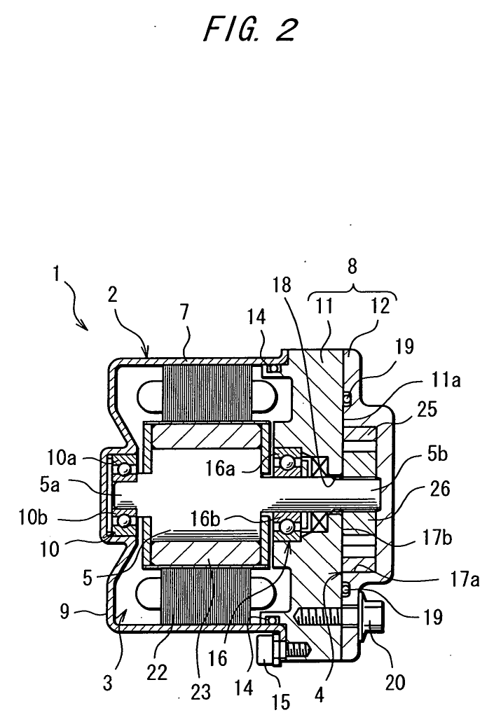

FIG. 2 shows an electric internal pump 1 as a comparative example, which principally differs from the electric internal pump 1 of the embodiment in that the second bearing 16 is disposed between the motor portion 3 and the rotor portion 4. With the bearings located as shown in the comparative example, the main shaft 5 is supported only by the second bearing 16 in an outboard-rotor fashion as seen from the rotor portion 4. Hence, the main shaft may suffer bending at its portion corresponding to the rotor portion 4, thus resulting in the faulty rotation.

According to the foregoing embodiment, however, the rotor portion 4 is located centrally of the main shaft 5 supported by both of the bearings 10, 16 in the inboard-rotor fashion. Hence, the main shaft 5 is supported in the inboard-rotor fashion with respect to both the motor portion 3 and the rotor portion 4, whereby the occurrence of the faulty rotation is avoided.

In the comparative example of FIG. 2, those components, the description of which is omitted, are similar to those of the pump 1 according to the first embodiment of FIG. 1 and are represented by the same reference characters, respectively.

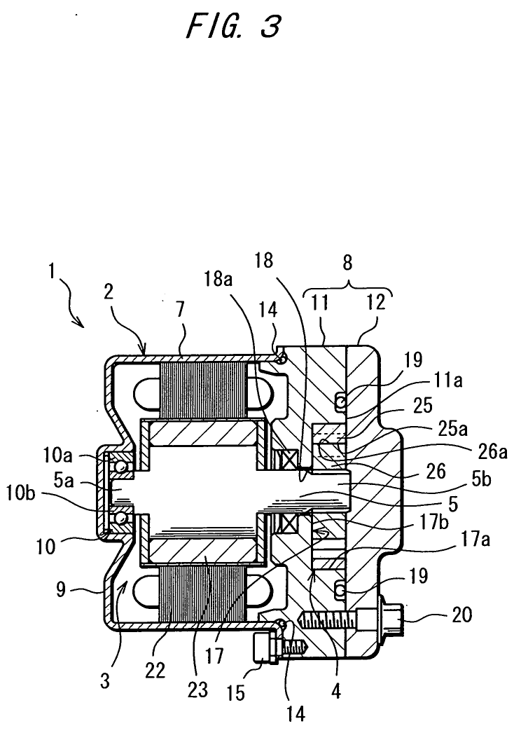

FIG. 3 shows an electric internal gear pump 1 according to a second embodiment hereof. In the second embodiment, like components to those of the pump 1 according to the first embodiment are represented by the same reference characters, respectively. Further, those features of the second embodiment, the description of which is omitted, are the same as those of the first embodiment.

In the second embodiment, the main shaft 5 is rotatably supported by the first bearing 10 at the one axial end 5a thereof. The other axial end 5b of the main shaft 5 extends through the through-hole 18 of the first section 11 to the rotor chamber 17, so that main shaft is provided with the rotor portion 4 at the other axial end 5b thereof.

A second bearing for supporting the other axial end of the main shaft 5 is constructed as a sliding bearing wherein an outer peripheral surface of the outer rotor 25 is in sliding contact with a housing peripheral surface 17a supporting the outer peripheral surface.

The main shaft 5 is rotatably supported by the second bearing 17a via the inner rotor 26. The housing peripheral surface 17a is finished to have a surface roughness Ra on the order of 1.6 or less in order to provide for a favorable sliding motion of the outer rotor 25. Although not supplied with an additional lubricant, the second bearing 17a is maintained in a favorable lubrication condition by means of oil in the rotor chamber 17.

According to the second embodiment, out of the bearings for the main shaft 5 that need be mounted to the axial opposite sides of the rotor 23 of the motor portion 3, one bearing (the second bearing 17a, or the bearing on the other axial end side) is incorporated in the rotor portion 4 itself (the outer periphery of the outer rotor defines the sliding bearing). Therefore, it is unnecessary to provide the bearing on the other axial side of the motor portion 3. That is, the bearing between the motor portion 4 and the rotor portion 4 is not required.

Accordingly, the pump may be reduced in the axial length. In addition, the number of bearings is decreased so that the reduction of components is accomplished. Thus is provided a low cost pump 1.

Furthermore, the second embodiment combines the trochoid pump featuring low machine noise with the sliding bearing featuring low machine noise, so that the pump produces low machine noises. Hence, the pump of the embodiment is suited for low noise applications.

It is noted that the invention is not limited to the foregoing embodiments and various changes and modifications may be made thereto within a scope defined by the appended claims.

What is claimed is:

1. An electric internal gear pump integrated with motor comprising:
a rotor portion including an outer rotor having an inner gear, and an inner rotor having an outer gear meshed with the inner gear;
an electric motor portion for driving the inner rotor into rotation; and
a main shaft comprising a drive shaft of the electric motor portion and a rotary shaft of the inner rotor, the drive shaft and rotary shaft formed coaxially and integrally,
the main shaft supported only by a first bearing and a second bearing disposed on axially opposite sides thereof,
the rotor portion located between the bearings.

2. An electric internal gear pump integrated with motor comprising:
a rotor portion including an outer rotor having an inner gear, and an inner rotor having an outer gear meshed with the inner gear;
an electric motor portion for driving the inner rotor into rotation; and
a main shaft comprising a drive shaft of the electric motor portion and a rotary shaft of the inner rotor, the drive shaft and rotary shaft formed coaxially and integrally,
the main shaft supported by a first bearing and a second bearing at places on axially opposite sides of the electric motor portion,
the first bearing supporting the main shaft at an axial end thereof opposite from the rotor portion,
the second bearing disposed on an outer periphery of the outer rotor for supporting the main shaft via the inner rotor.

3. An electric internal gear pump according to claim 2, wherein the second bearing is a sliding bearing constructed in a manner that the outer periphery of the outer rotor is in sliding contact with a pump housing.
